(19) United States
(12) Patent Application Publication
(10) Pub. No.: US 2024/0061823 A1
(43) Pub. Date: Feb. 22, 2024

(54) MEMORY-FRUGAL INDEX DESIGN IN STORAGE ENGINE

(71) Applicant: Alibaba Group Holding Limited, Grand Cayman (KY)

(72) Inventors: Yikang Xu, Redmond, WA (US); Rui Wang, Redmond, WA (US); Peng Xu, Milpitas, CA (US); Yu Du, Hangzhou (CN)

(21) Appl. No.: 18/270,830

(22) PCT Filed: Jan. 4, 2021
(86) PCT No.: PCT/CN2021/070193

§ 371 Date: Jul. 3, 2023

(51) Int. Cl. G06F 16/22; G06F 16/23

(52) U.S. Cl. CPC G06F 16/2272; G06F 16/2358; G06F 12/0253

(57) ABSTRACT

A storage engine may be configured to employ different formats for index fragments and index entries of respective records in the index fragments based at least in part on record properties of the respective records in the index fragments, to reduce an amount of memory space that is consumed or used for storing the index fragments in a memory associated with the storage engine, without compromising the efficiency of searching the records stored in a storage device. Using different formats for index fragments covering records of different record properties, the storage engine may further be configured to create, maintain, and update index mappings for records stored or included in the storage device, to provide functionalities of point-lookup, range query, deletion, and additions of the records in the storage device.

### CROSS-REFERENCE TO RELATED PATENT APPLICATIONS

This application claims priority to and is a continuation of PCT Patent Application No. PCT/CN2021/070193 filed on 4 Jan. 2021 and entitled “MEMORY-FRUGAL INDEX DESIGN IN STORAGE ENGINE,” which is incorporated herein by reference in its entirety.

### BACKGROUND

A cloud storage record engine provides a record-level API (Application Programming Interface) to allow users to perform insertion, deletion, point-lookup, and range query of records stored in a cloud system. The cloud storage record engine may work with storage devices, such as append-only storage devices (e.g., standard solid state devices, open-channel solid state devices, etc.).

In an append-only storage device, when a record is deleted, the record is marked as “deleted”, while a storage space of this record is not reclaimed until after an operation of garbage collection is performed on a block including the record. When the operation of garbage collection is performed on the block including the record, all data entries of the block are checked. Valid entries in the block are relocated and re-appended to a storage end, while deleted entries (such as records that have been marked as “deleted”, for example) are skipped. After the operation of garbage collection is completed, the block is cleared and is available and open for subsequent storage. The cloud storage record engine provides a functionality of garbage collection, and relieves both users and hardware or firmware from the duties or responsibilities of garbage collection.

To provide functionalities of point-lookup, range query, deletion and insertion, the cloud storage record engine needs to maintain a record-level index for mappings from a logical key of a record to a current, possibly already relocated physical location or address on an underlying storage device. Such index mappings need to be resided in memory of the cloud storage record engine to reduce the response latency of the cloud storage record engine, and thus improve the performance of the cloud storage record engine. However, naïve per-record mappings require or occupy a large amount of memory, especially for small records, leading to a high memory cost, which in turn may affect the response latency and performance of the cloud storage record engine due to an increase in time for searching through the index mappings within such large amount of memory.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment in which a storage engine may be used.

FIG. 2 illustrates the example storage engine in more detail.

FIG. 3 shows a schematic diagram depicting an example decision graph for performing conversions or transformations among different formats.

FIG. 4 shows an example method of generating or updating a record-level index.

### EXAMPLE ENVIRONMENT

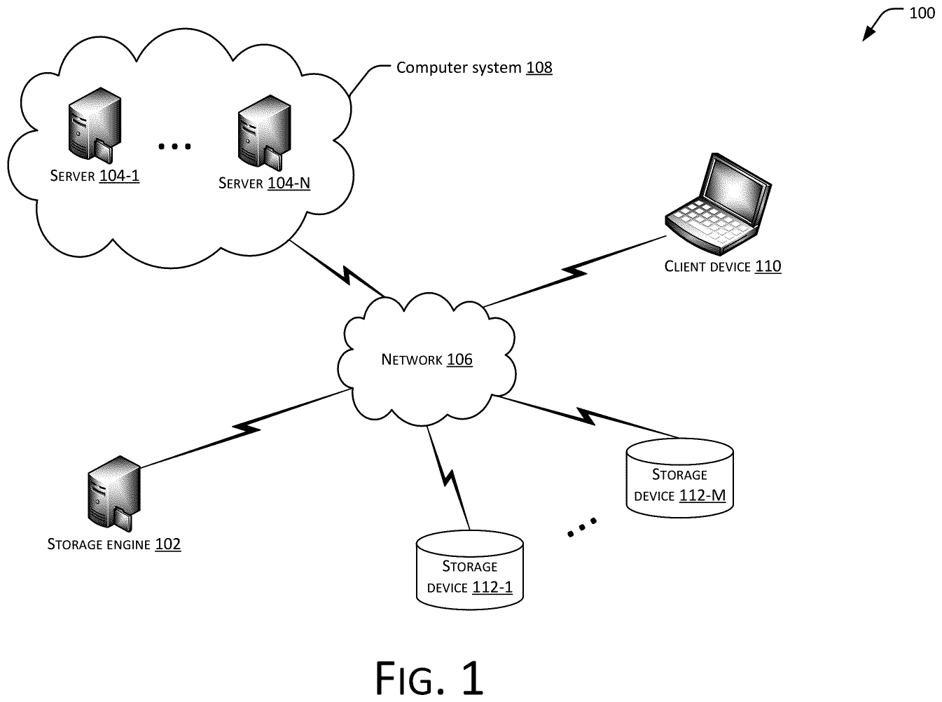

FIG. 1 illustrates an example environment 100 usable to implement a storage engine. The environment 100 may include a storage engine 102. In this example, the storage engine 102 is described to exist as an individual entity or device. Moreover, although in the examples described herein, the storage engine 102 may be implemented as a combination of software and hardware in individual entity or device, in other instances, the storage engine 102 may be implemented and distributed as services provided in one or more of a plurality of servers 104-1, 104-2, . . . , 104-N (which are collectively called as servers 104), which are connected and communicated via a network 106, where N is an integer greater than or equal to one. By way of example and not limitation, some or all of the functions of the storage engine 102 may be included in or provided by one or more servers 104. In other instances, the storage engine 102 may communicate data with the one or more servers 104 via the network 106.

In implementations, the one or more servers 104 may form a computer system 108 (such as a cloud computing architecture or a server cluster), or may form a part of the computer system 108. In implementations, the computer system 108 may provide a variety of services to a plurality of client devices (only one client device 110 is shown in FIG. 1 for the sake of simplicity). In this example, the storage engine 102 may be described to be a part of the computer system 108. In other instances, the storage engine 102 may be an individual entity that provides supporting services to the computer system 108.

In implementations, each of the one or more servers 104 may be implemented as any of a variety of devices having computing capabilities, and may include, but are not limited to, a processor (which may include a single-core processor or a multi-core processor), a desktop computer, a notebook or portable computer, a handheld device, a netbook, an Internet appliance, a tablet or slate computer, a mobile device (e.g., a mobile phone, a personal digital assistant, a smart phone, etc.), a server computer, etc., or a combination thereof.

The network 106 may be a wireless or a wired network, or a combination thereof. The network 106 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. Wired networks may include an electrical carrier connection (such a communication cable, etc.) and/or an optical carrier or connection (such as an optical fiber connection, etc.). Wireless networks may include, for example, a WiFi network, other radio frequency networks (e.g., Bluetooth®, Zigbee, etc.), etc.

In implementations, the environment 100 may further include one or more storage devices 112-1, . . . , 112-M (which are collectively called as storage devices 112), where M is an integer greater than or equal to one. In implementations, the storage engine 102 may be configured to employ different formats for index fragments and index entries of respective records in the index fragments based at least in part on record properties of the respective records in the index fragments, to reduce an amount of memory space that is consumed or used for storing the index fragments in a memory associated with the storage engine 102, without compromising the efficiency of searching the records stored in the one or more storage devices 112. In implementations, with the different formats used for the index fragments, the storage engine 102 may further be configured to create, maintain, and update index mappings for records stored or included in the one or more storage devices 112, to provide functionalities of point-lookup, range query, deletion, and additions of the records in the one or more storage devices 112.

### Example Storage Engine

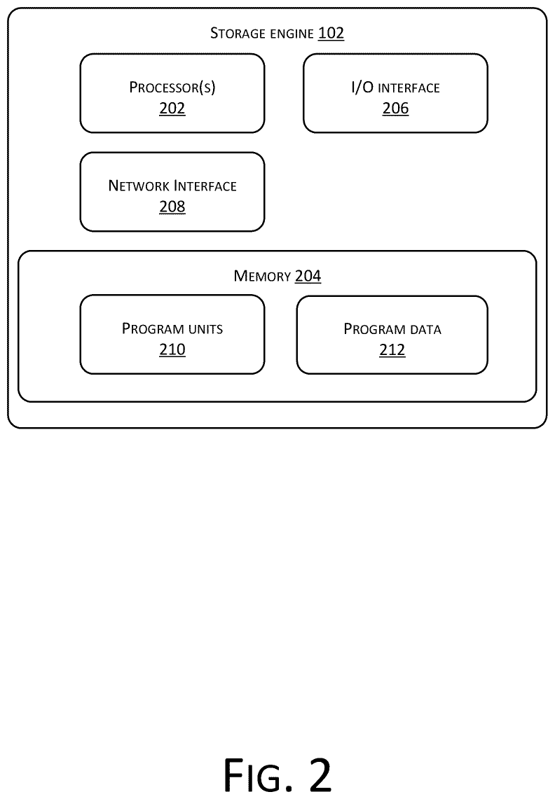

FIG. 2 illustrates the storage engine 102 in more detail. In implementations, the storage engine 102 may include, but is not limited to, one or more processors 202, memory 204, an input/output (I/O) interface 206, and/or a network interface 208. In implementations, some of the functions or components of the storage engine 102 (for example, the one or more processors 202) may be implemented using hardware, for example, an ASIC (i.e., Application-Specific Integrated Circuit), a FPGA (i.e., Field-Programmable Gate Array), and/or other hardware. In this example, the storage engine 102 may be associated and/or connected to one or more storage devices (such as the one or more storage devices 112), and configured to provide services and/or functionalities for processing data (such as records, etc.) included in the one or more storage devices.

In implementations, the processors 202 may be configured to execute instructions that are stored in the memory 204, and/or received from the input/output interface 206, and/or the network interface 208. In implementations, the processors 202 may be implemented as one or more hardware processors including, for example, a microprocessor, an application-specific instruction-set processor, a physics processing unit (PPU), a central processing unit (CPU), a graphics processing unit, a digital signal processor, a tensor processing unit, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 204 may include processor readable media in a form of volatile memory, such as Random Access Memory (RAM) and/or non-volatile memory, such as read only memory (ROM) or flash RAM. The memory 204 is an example of processor readable media.

The processor readable media may include a volatile or non-volatile type, a removable or non-removable media, which may achieve storage of information using any method or technology. The information may include a processor readable instruction, a data structure, a program module or other data. Examples of processor readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a processor and/or a computing device. As defined herein, the processor readable media does not include any transitory media, such as modulated data signals and carrier waves.

Although in this example, exemplary hardware components are described in the storage engine 102, in other instances, the storage engine 102 may further include other hardware components and/or other software components such as program unit(s) 210 to execute instructions stored in the memory 204 for performing various operations. In implementations, the storage engine 102 may further include program data 212 that stores data used for performing operations associated with record-level index for mappings for the storage devices 112. Example Indexing Configuration

In implementations, the storage engine 102 may store data in units of data chunks (or simply called as chunks). In implementations, a size of a chunk may be defined by the storage engine 102 or a type of a corresponding storage device (e.g., the storage device 112). By way of example and not limitation, a size of a chunk may be defined by the storage device 112 and/or the storage engine 102, and may be in units of megabytes (MB), such as 64 MB. After a chunk is allocated, the storage engine 102 may allow users to add or append data (such as records, for example) into the chunk. In implementations, consecutive records may be logically adjacent, with an in-chunk end offset of a record being equal to a start offset of another record that follows thereafter. In implementations, a start offset of a first record in a chunk is zero, and a logical size of a record may be defined as a gap or difference between a start offset and an end offset of the record. In implementations, a logical size of a record may be bounded by an upper limit (e.g., 4 MB, 8 MB, etc.) which may be defined by the storage engine 102 or the type of the storage device 112 that stores the record. In implementations, a key of a record may be represented by a combination of an identifier (or abbreviated as ID) of a chunk that stores the record, and a start offset of the record within the chunk.

In implementations, the storage engine 102 may be configured to manage and process chunks that are stored in storage devices (such as the storage devices 112). In implementations, the storage device 112 may store data in units of superblocks, and a size of a superblock may be defined by the storage device 112 and/or the storage engine 102. Examples of the size of the superblock may be in units of GB, such as 16 GB, etc. In implementations, the storage engine 102 or the storage device 112 may append or add records to a superblock until the superblock is full, and may re-open the superblock to accept new records from the beginning of the superblock after clearing or erasing data (such as records) stored in the superblock. In implementations, the storage engine 102 or the storage device 112 may store a chunk in one or more superblocks, and may store multiple chunks in a superblock in an interleaving way.

In implementations, a superblock may include multiple (e.g., 4 million, 8 million, etc.) physically consecutive sectors, with each sector having a size of units of kilobytes (KB), such as 4 KB. In implementations, an entire record may be stored continuously in one or more consecutive sectors within a superblock. In implementations, a physical location of a record may be represented by an identifier of a superblock storing the record, an identifier of a first sector that stores the record (or called as a first containing sector hereinafter), an offset of the record in the first containing sector, and a physical size of the record. In implementations, a physical size of a record may be correlated to and potentially slightly larger than a logical size of the record. Without loss of generality, a chunk may be served by or stored in a single storage device, and may not be served by or stored across a plurality of storage devices.

In implementations, the storage engine 102 may maintain a chunk-level in-memory index, i.e., mappings from a chunk identifier (i.e., an identifier of a chunk, or a chunk ID) to a combination of a device identifier (i.e., an identifier of a storage device, or a device ID) and a chunk index, given that the chunk is served by or stored in a single storage device. In implementations, for each storage device, the storage engine 102 may further maintain a record-level index, i.e., a mapping from a combination of a chunk index and a start offset of a record to a combination of a superblock ID (i.e., an identifier of a superblock that includes the record), a first containing sector ID (i.e., an identifier of a first containing sector), an offset of the record in the first containing sector, a physical size of the record. In implementations, the storage engine 102 may adopt a plurality of indexing methods to reduce an amount of memory occupied by the record-level index.

### Intra-Sector Indexing

In implementations, a sector may store or include a start offset of a first record included in the sector in a special area, such as a sector metadata area (or called as an 00B (Out-Of-Band) area). In implementations, a data header of a record may store or include information of a physical size of the record in a storage device. In implementations, after an identifier of a first containing sector for storing a record is determined, a physical offset of the record in the sector may be determined by first finding or obtaining a start offset of a first record in the sector, and then scanning subsequent records in the sector, which may be loaded into the memory of the storage engine 102. In implementations, a physical location of a record may be reduced to a combination of an identifier of a superblock that includes the record, an identifier of a first containing sector, and a sector count (i.e., the number of sectors that are used to store the record).

### Chunk Index Segmentation

In implementations, a chunk may be logically divided or partitioned into a plurality of consecutive chunk segments. In implementations, a chunk segment may cover or include a continuous range of key space of records included therein, which may be stored in a single superblock. In implementations, a key range of a chunk segment may be represented by a start offset and an end offset of the chunk segment. By way of example and not limitation, a key range of a chunk segment may be represented as [a start offset, an end offset), with a lower bound being inclusive and an upper bound being exclusive. In implementations, different chunk segments may have disjoint key ranges. In implementations, a record may be included in a single chunk segment, and may not be included across a plurality of chunk segments.

In implementations, a superblock may include chunk segments of multiple chunks. In implementations, multiple chunk segments of a chunk may exist or be included in a superblock, and key ranges of these chunk segments may or may not be merged or combined into a larger continuous key space. In an event that the key ranges of these chunk segments cannot be merged or combined into a larger continuous key space, these chunk segments may be stored in the superblock as separate chunk segments.

In implementations, the storage engine 102 may maintain a record-level in-memory index for records belonging to a respective key range of each chunk segment. Such per-segment index may be called as chunk segment index metadata (CSIM) hereinafter. In implementations, all CSIMs of chunk segments of a chunk may be combined to form a record-level index of that chunk, and may be linked together to form a predefined data structure according to a certain order to enable the storage engine 102 to perform a quick search for a particular chunk segment (and hence a particular record). By way of example and not limitation, CSIMs of chunk segments of a chunk may be located together, for example, according to (such as an ascending order) of respective start offsets of the chunk segments, to allow the storage engine 102 to perform a quick search (such as a binary search, etc.) to find a particular chunk segment (and hence a particular record).

In implementations, to search for a certain record in a certain chunk, the storage engine 102 may first locate a CSIM group (e.g., a group of CSIMs of chunk segments for the chunk) for the chunk, and then locate a CSIM for the record. In implementations, a CSIM may provide mappings from record start offsets (i.e., start offsets of records) to (first containing sector ID, sector count) (i.e., combinations of identifiers of respective first containing sectors including the records and respective sector counts), without the need of chunk index (which is a per-chunk value) and superblock ID (which is a per-segment value).

For example, if sectors have a size of 4 KB, and upper limit configurations for physical sizes of superblocks, chunks, and records are 16 GB, 2 GB, and 8 MB respectively, a record start offset may be represented using 31 bits, a first containing sector ID may be represented using 22 bits, and a sector count may be represented using 11 bits. In this case, each entry of a CSIM may be represented using 8 bytes (i.e., 64 bits=31+22+11). In this example, a 4 TB (terabytes) device may store 1 billion records, 4 KB each, and a total amount of memory required for a CSIM index is about 8 GB, without any memory usage optimization.

### In-Segment Index Fragmentation

In implementations, a CSIM of a chunk segment may be divided or partitioned into a plurality of index fragments. In implementations, each index fragment of the CSIM of the chunk segment may occupy a fixed size or amount of memory, such as 512 B, and may represent a subset of a key range associated with the chunk segment. In implementations, each index fragment may represent a sub-key range [fragment start offset, fragment end offset), with a lower bound being inclusive and an upper bound being exclusive, for example. In implementations, index fragments of a CSIM may be grouped together to form a predefined data structure (such as a linked list, for example) to facilitate subsequent searches. For example, index fragments of a CSIM may be grouped together to form an array according to a sorted order (such as an ascending order, for example) of respective start offsets (i.e., fragment start offsets) of the index fragments to allow a binary search for the index fragments. In implementations, a record with a start offset (which may act as a key of the record) is located within a sub-key range (i.e., [fragment start offset, fragment end offset)) of an index fragment is indexed in that index fragment. In implementations, after a record is deleted, an index entry associated with the record may be removed from a corresponding index fragment, or the index entry associated with the record may be remained in the corresponding index fragment with a special deletion label or marker indicating that this record is deleted. In implementations, each index fragment may be individually or separated optimized in terms of memory usage, for example, by considering properties of records covered in a corresponding sub-key range of the respective index fragment.

### Index Fragment Structure

In implementations, the storage engine 102 may take advantage of a plurality of record properties of records covered in a sub-key range of an index fragment to further reduce a memory usage or occupancy of per-index index entries of the records, and enable more index entries to be included or stored in each index fragment, without compromising the search efficiency. By way of example and not limitation, the storage engine 102 may provide a variety of different index fragment formats based on these record properties. In implementations, the plurality of record properties of the records covered in the sub-key range of the index fragment may include, but are not limited to, whether keys of the plurality of records are continuous or discrete, whether logical sizes of the plurality of records are fixed or varied (and/or same or different), the number of sectors that are used to store or include the plurality of records, whether the sectors that are used to store or include the plurality of records are adjacent to each other, etc.

In implementations, each record needs to have or be associated with an index entry. After a record is deleted from a storage device, an associated index entry may be marked for deletion and may not be removed from the storage device immediately until after an operation of garbage collection is performed on a chunk, a sector or a superblock that originally stores the record. In implementations, when an operation of garbage collection is performed, an index fragment may choose to index only valid records and skip records that are deleted, if the number of such deleted records is greater than or equal to predefined threshold, which thus leads a situation that key entries or index entries in the index fragment are discrete. Additionally or alternatively, key entries or index entries in an index fragment are said to be discrete if corresponding key entries or index entries of deleted records (i.e., records that are deleted or marked to be deleted) covered by the index fragment are discarded and not maintained in the index fragment.

In implementations, if all records covered in a sub-key range of an index fragments are present, i.e., having an index entry (or in other words, keys are continuous), a gap encoding of record start offset may be used, where a start offset of a current record may be derived based on a start offset and a logical size of a previous record.

In implementations, if an index fragment includes continuous keys and if records in the index fragments have the same fixed logical size, the storage engine 102 may not need to include respective start offsets of the records (i.e., record start offsets) in index entries of the index fragment, and may derive the record start offsets from a base start offset associated with the index fragment which sub-key range covers these records.

In implementations, a record logical size (i.e., a logical size of a record) may be categorized into multiple size ranges. In implementations, the multiple size ranges may include a first range, a second range, a third range, etc. In implementations, if all records of an index fragment belong to a same size range, a same number of bits may be used to encode a logical size of each record corresponding to that index fragment. In implementations, the smaller a logical size of a record is, the fewer the number of bits is to be used.

In implementations, a record physical size (i.e., a physical size of a record) in terms of the number of sectors may also be categorized into a plurality of different size ranges. In implementations, if all records of an index fragment belong to a same size range, a same number of bits may be used to encode a sector count of each record corresponding to that index fragment. In implementations, a logical size and a physical size of a record may not be the same, and may be correlated. For example, a record with a small logical size may occupy a small number of sectors.

In implementations, records that are covered by a sub-key range of an index fragment may be stored in more than one sector in a superblock. In this case, a span of sectors of the index fragment may have a limited size. In implementations, an index fragment may have a base sector ID, and a relative sector ID (i.e., relative to the base sector ID) for an index entry of each individual record corresponding to the index fragment may be included or stored. In implementations, depending on a size of a span, different number of bits may be used to represent a relative sector ID. The smaller the span is, the fewer the number of bits is to be used. In implementations, since an operation of garbage collection can cause records of a chunk to become more clustered, the operation of garbage collection can reduce the size of the span.

In implementations, if sectors storing all records within an index fragment are adjacent to each other, i.e., a starting sector of a current record may be the same as or immediately after an ending sector of a previous record. In this case, a relative sector ID of the starting sector of the current record may be derived from the ending sector of the previous record, and only one flag may be needed to indicate whether the starting sector of the current record is the same as or immediately after the ending sector of the previous record.

### Index Fragment Header

In implementations, an index fragment header of an index fragment may be located at the beginning of the index fragment, and may include a plurality of fields. In implementations, the plurality of fields may include, but are not limited to, a chunk index, a format type, a base start offset, a record size range, a flag indicating whether logical size is variable, a superblock ID, etc. By way of example and not limitation, an index fragment header may have a size of 16 bytes, and may include a plurality of fields (such as a chunk index, a format type, a base start offset, a record size range, a flag indicating whether logical size is variable, a superblock ID) having sizes as 24 bits, 8 bits, 32 bits, 2 bits (a number of size ranges is assumed to be three or four in this example), 1 bit, and 24 bits respectively.

### In-Fragment Mid-Tier Index

In implementations, if records in an index fragment do not have the same and fixed logical size, index entries of the records in the index fragment may be divided into multiple groups, with each group covering a respective sub-key range of records within a CSIM. In implementations, a group entry for each group may be stored and include a relative start offset relative to a base start offset of that index fragment. In implementations, a record start offset of a record within a group may be derived or determined based on the base start offset of the index fragment, a relative start offset of the group, and corresponding logical sizes of one or more records prior to the record in the same group. In implementations, group entries of the multiple groups in the index fragment may be stored and located at the end of the index fragment.

In implementations, the group entries may serve as a mid-tier index within the index fragment, thus speeding up searches that are performed in the index fragment. By way of example and not limitation, a search for a record whose index is covered by a sub-key range of the index fragment may be performed by first checking the group entries in the index fragment to obtain a group entry of a group including an index entry of the record, and then processing the group accordingly, thus avoiding or reducing the computational and time costs due to the need of linear scanning of index entries in the index fragment if the index fragment does not have group entries.

### Record Delete Index

In implementations, when a record is deleted, an index entry of the record may be marked as deleted. In implementations, when an operation of garbage collection is performed, such index entry of the record may be removed from an index fragment to which the index entry originally or previously belongs. In implementations, in some instances, an index entry for a deleted record may be desirable to be maintained or kept to allow a key space of an index fragment to which the index entry belongs to be continuous, a special index entry (which may be called as a tombstone index entry, for example), rather than an original or full index entry for the deleted record, may be used instead. In implementations, such special index entry (or the tombstone index entry) for the deleted record may occupy an amount of memory space that is less than the original or full index entry for the deleted record.

### Index Fragment Formats

In implementations, depending on properties of records covered by a sub-key range of a respective index fragment (e.g., whether keys of the records are continuous or discrete, whether logical sizes of the records are fixed or varied (and/or same or different), the number of sectors that are used to store or include the records, whether the sectors that are used to store or include the records are adjacent to each other, etc.), different index fragment formats for different index fragments may be developed and used. By way of example and not limitation, an example of nine different formats is described hereinafter and is used for the sole purpose of illustrating how to develop formats for index fragments. More or fewer index fragment formats and/or index fragment formats that are different from those described in the present disclosure may be developed and used based on concepts and principles disclosed in the present disclosure. Furthermore, in this example, sectors are described to have a size of 4 KB, and upper limit configurations for physical sizes of superblocks, chunks, and records are 16 GB, 2 GB, and 8 MB respectively.

In implementations, record logical sizes (i.e., logical sizes of records) may be categorized into a plurality of logical size ranges. By way of example and not limitation, in this example, the record logical sizes are described to be categorized into three logical size ranges, namely, a first logical size range (any logical size less than 8 KB), a second logical size range (any logical size less than 32 KB), and a third logical size range (any logical size less than 8 MB).

In implementations, record physical sizes (i.e., physical sizes of records) may also be categorized into a plurality of physical size ranges. By way of example and not limitation, in this example, the physical logical sizes are described to be categorized into three physical size ranges, namely, a first physical size range (any physical size less than or equal to 3 sectors), a second physical size range (any physical size less than or equal to 9 sectors), and a third physical size range (any physical size less than or equal to 2048 sectors (i.e., 8 MB)).

In implementations, sector spans may also be categorized into a plurality of sector span ranges. By way of example and not limitation, in this example, the sector span ranges are described to be categorized into four sector span ranges, namely, a first sector span range (a containing sector ID of any record covered by an index fragment being less than 337 sectors away from a base sector ID recorded in a format header of the index fragment), a second sector span range (a containing sector ID of any record covered by an index fragment being less than 4096 sectors away from a base sector ID recorded in a format header of the index fragment), a third sector span range (a containing sector ID of any record covered by an index fragment being less than 1 million sectors away from a base sector ID recorded in a format header of the index fragment), and a fourth sector span range (a containing sector ID of any record covered by an index fragment being less than 2 million sectors (i.e., about 8 GB) away from a base sector ID recorded in a format header of the index fragment).

In implementations, the following Table 1 shows relationships between corresponding values or types of example record properties of records and different index fragment formats, with NR representing no restrictions, Y representing “true”, and an empty box representing “false”.

TABLE 1

| Index Fragment Format | | 0 | 1 | 2 | 3 | 4 | 5 | 6 | 7 | 8 |
|---|---|---|---|---|---|---|---|---|---|---|
| Key | Continuous | Y | Y | Y | Y | Y | Y | Y | | |
| | Discrete | | | | | | | | Y | Y |
| Record | Same/Fixed | NR | NR | NR | NR | NR | Y | Y | NR | NR |
| logical | Different | | | | | | | | | |
| size | | | | | | | | | | |
| Record | First record | Y | | | | NR | | | NR | Y |
| logical | size range | | | | | | | | | |
| size | Second | | Y | Y | | | Y | | | |
| | record size | | | | | | | | | |
| | range | | | | | | | | | |
| | Third | | | | Y | | | Y | | |
| | record size | | | | | | | | | |
| | range | | | | | | | | | |
| Record | First | Y | | | | NR | | | NR | ✓ Y |
| physical | physical | | | | | | | | | |
| size | size range | | | | | | | | | |
| | Second | | Y | Y | | | Y | | | |
| | physical | | | | | | | | | |
| | size range | | | | | | | | | |
| | Third | | | | Y | | | Y | | |
| | physical | | | | | | | | | |
| | size range | | | | | | | | | |
| Sector | First sector | Y | | | | NR | | NR | NR | Y |
| span | span range | | | | | | | | | |
| | Second | | Y | | | | Y | | | |
| | sector span | | | | | | | | | |
| | range | | | | | | | | | |
| | Third | | | Y | | | | | | |
| | sector span | | | | | | | | | |
| | range | | | | | | | | | |
| | Fourth | | | | Y | | | | | |
| | sector span | | | | | | | | | |
| | range | | | | | | | | | |

In implementations, in this example, when keys of records covered by a sub-key range of an index fragment are continuous, record logical sizes of the records are within the first record logical size range, record physical sizes of the records are within the first record physical size range, and the index fragment has a sector span belonging to the first sector span range, a format 0 may be used for such index fragment. A header of format 0 (or abbreviated as a format_0 header) of an index fragment may have a size of 8 bytes, and may include a plurality of key fields, including, but are not limited to, a base sector ID (e.g., 22 bits in size), a largest relative sector ID (e.g., 10 bits in size), a group count (e.g., 8 bits in size), and an offset of a first group entry (e.g., 16 bits in size). In implementations, a group entry (which has a size of 4 bytes) may include fields, such as a relative start offset (e.g., 23 bits in size), and an offset-in-fragment of a first index entry (e.g., 9 bits in size). In this example, each group may cover or include 16 index entries. In implementations, an index entry (which has a size of 3 bytes) may include, for example, a sector range (e.g., bits 0˜9, 10 bits in size), a logical size (e.g., bits 10˜22, 13 bits in size), and a tombstone flag (e.g., bit 23, 1 bit in size, and equal to 0), according to a convention that significant bits are located at a low byte address. In this example, when a sector range of an index entry associated with a record has a predefined value, such as a value of 1023, this indicates that the record is deleted. In implementations, a sector range may be calculated as relative sector ID×3+(sector count−1). Correspondingly, a relative sector ID may be derived or determined as (sector range/3), and a sector count may derived or determined as (sector range % 3+1). In implementations, a tombstone index entry (which has a size of 2 bytes) for a deleted record may include multiple fields including, for example, a logical size (e.g., bits 2˜14, 13 bits in size) and a tombstone flag (e.g., bit 15, 1 bit in size, and equal to 1), according to a convention that significant bits are located at a low byte address.

In implementations, in this example, when keys of records covered by a sub-key range of an index fragment are continuous, record logical sizes of the records are within the second record logical size range, record physical sizes of the records are within the second record physical size range, and the index fragment has a sector span belonging to the second sector span range, a format 1 may be used for such index fragment. A header of format 1 (or abbreviated as a format_1 header) of an index fragment may have a size of 4 bytes, and may include a plurality of key fields, including, but are not limited to, a relative sector ID (e.g., bits 0˜11, 12 bits in size), a sector count (e.g., bits 12˜15, 4 bits in size), a logical size (bits 16˜30, 15 bits in size), and a tombstone flag (bit 31, 1 bit in size, and equal to 0). In implementations, when a combination (a total of 2 bytes in size) of a relative sector ID and a sector count of an index entry associated with a record has a certain value, such as 0xFFFF in this example, this indicates that the record is deleted. In implementations, a tombstone index entry (e.g., 2 bytes in size) for a deleted record may include, for example, a logical size (e.g., bits 0˜14, 15 bits in size) and a tombstone flag (bit 15, 1 bit in size, and equal to 1).

In implementations, in this example, when keys of records covered by a sub-key range of an index fragment are continuous, record logical sizes of the records are within the second record logical size range, record physical sizes of the records are within the second record physical size range, and the index fragment has a sector span belonging to the third sector span range, a format 2 may be used for such index fragment. A header of format 2 (or abbreviated as a format_2 header) of an index fragment may have a size of 8 bytes, and may include a plurality of key fields, including, but are not limited to, a base sector ID (e.g., 24 bits in size), a group count (e.g., 8 bits in size), a largest relative sector ID (e.g., 22 bits in size), and an offset of a first group entry (e.g., 10 bits in size). In implementations, the format_2 header may have a group entry format that is the same as that of the format_0 header, i.e., having multiple fields such as a relative start offset and an offset-in-fragment of a first index entry. In implementations, each group may cover or include 8 index entries. In implementations, an index entry (which has a size of 5 bytes) may include, for example, a relative sector ID (e.g., bits 0˜19, 20 bits in size), a sector count (e.g., bits 20˜23, 4 bits in size), a logical size (e.g., bits 24˜38, 15 bits in size), and a tombstone flag (e.g., bit 39, 1 bit in size, and equal to 0), according to a convention that significant bits are located at a low byte address. In implementations, when a combination (a total of 3 bytes in size) of a relative sector ID and a sector count of an index entry associated with a record has a certain value, such as 0xFFFFFF in this example, this indicates that the record is deleted. In implementations, a tombstone index entry (e.g., 2 bytes in size) for a deleted record may include, for example, a logical size (e.g., bits 0˜14, 15 bits in size) and a tombstone flag (bit 15, 1 bit in size, and equal to 1). In implementations, since records of a chunk become more clustered after garbage collection, an index fragment originally covering these records may potentially have its header to transform or convert from a format_2 header to a format_1 header.

In implementations, in this example, when keys of records covered by a sub-key range of an index fragment are continuous, record logical sizes of the records are within the third record logical size range, record physical sizes of the records are within the third record physical size range, and the index fragment has a sector span belonging to the fourth sector span range, a format 3 may be used for such index fragment. A header of format 3 (or abbreviated as a format_3 header) of an index fragment may have a size of 8 bytes, and may include a plurality of key fields, including, but are not limited to, a base sector ID (e.g., 24 bits in size), a group count (e.g., 8 bits in size), a largest relative sector ID (e.g., 23 bits in size), and an offset of a first group entry (e.g., 9 bits in size). In implementations, a group entry (which has a size of 8 bytes) may include fields, such as a relative start offset (e.g., 32 bits in size), and an offset-in-fragment of a first index entry (e.g., 9 bits in size). In this example, each group may cover or include 16 index entries. In implementations, an index entry (which has a size of 7 bytes) may include, for example, a relative sector ID (e.g., bits 0˜20, 21 bits in size), a sector count (e.g., bits 21˜31, 11 bits in size), a logical size (e.g., bits 32˜54, 23 bits in size), and a tombstone flag (e.g., bit 55, 1 bit in size, and equal to 0), according to a convention that significant bits are located at a low byte address. In implementations, when a combination (a total of 4 bytes in size) of a relative sector ID and a sector count of an index entry associated with a record has a certain value, such as 0xFFFFFFFE in this example, this indicates that the record is deleted. In implementations, a deletion or tombstone index entry (e.g., 3 bytes in size) for a deleted record may include, for example, a logical size (e.g., bits 0˜22, 23 bits in size) and a tombstone flag (bit 23, 1 bit in size, and equal to 1).

In implementations, in this example, when keys of records covered by a sub-key range of an index fragment are continuous, and sectors storing the records are continuous or adjacent to each other (i.e., records are physically adjacent or stored together in adjacent sectors), a format 4 may be used for such index fragment. In implementations, the format 4 may not have any restrictions on logical sizes and physical sizes of records covered by an index fragment that uses the format 4 for its header, and may further not have any restrictions on a span size of sectors storing the records covered by the index fragment. A header of format 4 (or abbreviated as a format_4 header) of an index fragment may have a header format that is the same as that of a header of format 3 (or a format_3 header). In implementations, a group entry (which has a size of 8 bytes) may include a plurality of key fields, which include, but are not limited to, a relative start offset (e.g., 26 bits in size), an offset-in-fragment of a first index entry (e.g., 9 bits in size), and a relative sector ID (e.g., 23 bits in size). In this example, each group may cover or include 16 index entries. In implementations, an index fragment using a format_4 header may accept different record sizes (in terms of both logical sizes and physical sizes). In this example, a record may be considered or counted as a large record if a logical size thereof is no smaller than 32 KB, or a sector count thereof is no smaller than 18 sectors. In implementations, whether a record is large is recorded in a separate bit stream, which may be located, for example, at the end of the index fragment and immediately after a storage position for group entries of the index fragment. In implementations, sizes of index entries associated with records may be different, and depend on whether the associated records are large or not. For example, an index entry for a large record may have a size of 5 bytes, and may include a plurality of fields, such as a sector count (e.g., bits 0˜12, 13 bits in size), an adjacency flag (e.g., bit 13, 1 bit, true indicating that a starting sector ID is same as a prior record's last sector), a stats (e.g., bits 14˜15, 2 bits in size, including a deleted flag), a logical size (e.g., bits 16˜38, 23 bits in size), and a tombstone flag (bit 39, 1 bit in size, and equal to 0). In implementations, in this example, a tombstone index entry for a large deleted record may have a size of 3 bytes, and may include a plurality of fields, such as a logical size (e.g., bits 0˜22, 23 bits in size) and a tombstone flag (bit 23, 1 bit in size, and equal to 1). In implementations, an index entry for a record that is not considered or counted as large (or simply called a non-large record) may have a size of 3 bytes, and may include a plurality of fields, such as a sector count (e.g., bits 0˜4, 5 bits in size), an adjacency flag (e.g., bit 5, 1 bit, true indicating that a starting sector ID is same as a prior record's last sector), a stats (e.g., bits 6˜7, 2 bits in size, including a deleted flag), a logical size (e.g., bits 8˜22, 15 bits in size), and a tombstone flag (bit 23, 1 bit in size, and equal to 0). In implementations, in this example, a tombstone index entry for a non-large record that is deleted may have a size of 2 bytes, and may include a plurality of fields, such as a logical size (e.g., bits 0˜14, 15 bits in size) and a tombstone flag (bit 15, 1 bit in size, and equal to 1).

In implementations, in this example, when keys of records covered by a sub-key range of an index fragment are continuous, record logical sizes of the records are the same and are within the second record logical size range, record physical sizes of the records are within the second record physical size range, and the index fragment has a sector span belonging to the second sector span range, a format 5 may be used for such index fragment. A header of format 5 (or abbreviated as a format_5 header) of an index fragment may have a size of 8 bytes, and may include a plurality of key fields, including, but are not limited to, a base sector ID (e.g., 22 bits in size), a largest relative sector ID (e.g., 18 bits in size), and a fixed logical size (e.g., 24 bits in size). In implementations, the format_5 header may not have any group entry. In implementations, an index entry (which has a size of 2 bytes) may include, for example, a relative sector ID (e.g., bits 0˜11, 12 bits in size) and a sector count (e.g., bits 12˜15, 4 bits in size), according to a convention that significant bits are located at a low byte address. In implementations, the format_5 header may not have a different tombstone index entry format for a deleted record. In implementations, when a combination (a total of 2 bytes in size) of a relative sector ID and a sector count of an index entry associated with a record has a certain value, such as 0xFFFF in this example, this indicates that the record is deleted. Additionally, in response to a combination of a relative sector ID and a sector count of an index entry associated with a record having a designated value, such as 0xFFFE in this example, this indicates that the record has become a tombstone.

In implementations, in this example, when keys of records covered by a sub-key range of an index fragment are continuous, record logical sizes of the records are the same and are within the third record logical size range, and record physical sizes of the records are within the third record physical size range, a format 6 may be used for such index fragment. A header of format 6 (or abbreviated as a format_6 header) of an index fragment may have a size of 12 bytes, and may include a plurality of key fields, including, but are not limited to, a base sector ID (e.g., 22 bits in size), a largest relative sector ID (e.g., 23 bits in size), and a fixed logical size (e.g., 24 bits in size). In implementations, the format_6 header may not have any group entry. In implementations, an index entry (which has a size of 4 bytes) may include, for example, a relative sector ID (e.g., bits 0˜20, 21 bits in size) and a sector count (e.g., bits 21˜31, 11 bits in size), according to a convention that significant bits are located at a low byte address. In implementations, the format_6 header may not have a different tombstone index entry format for a deleted record. In implementations, when a combination (a total of 4 bytes in size) of a relative sector ID and a sector count of an index entry associated with a record has a certain value, such as 0xFFFFFFFF in this example, this indicates that the record is deleted. Additionally, in response to a combination of a relative sector ID and a sector count of an index entry associated with a record having a designated value, such as 0xFFFFFFFE in this example, this indicates that the record has become a tombstone.

In implementations, in this example, when keys of records covered by a sub-key range of an index fragment are discrete, i.e., deleted records do not have or keep index entries in the index fragment, a format 7 may be used for such index fragment. A header of format 7 (or abbreviated as a format_7 header) of an index fragment may have a header format and a group entry format that are the same as those of a format_3 header. In implementations, in this example, each group may include or cover 16 index entries. In implementations, an index entry may have a size of 11 bytes, and may include a plurality of key fields, including, but are not limited to, a relative sector ID (e.g., bits 0˜20, 21 bits in size), a sector count (e.g., bits 21˜31, 11 bits in size), a logical size (bits 33˜55, 23 bits in size), a relative start offset (bits 56-86, 31 bits in size), and a tombstone flag (bit 87, 1 bit in size, and equal to 0). In implementations, the relative start offset is relative to a base start offset of the index fragment. In implementations, when a combination (a total of 4 bytes in size) of a relative sector ID and a sector count of an index entry associated with a record has a certain value, such as 0xFFFFFFFE in this example, this indicates that the record is deleted. In implementations, in this example, a tombstone index entry for a deleted record may have a size of 7 bytes, and may include a plurality of fields, such as a logical size (e.g., bits 1˜23, 23 bits in size), a relative start offset (e.g., bits 24˜54, 31 bits in size), and a tombstone flag (bit 55, 1 bit in size, and equal to 1).

In implementations, in this example, when keys of records covered by a sub-key range of an index fragment are discrete, record logical sizes of the records are within the first record logical size range, record physical sizes of the records are within the first record physical size range, the index fragment has a sector span belonging to the first sector span range, an offset of any record in the index fragment is no more than 32 MB away from a base start offset recorded in the a header of the index fragment, a format 8 may be used for such index fragment. A header of format 8 (or abbreviated as a format_8 header) of an index fragment may have a header format and a group format that are the same as those of a format_3 header. Each group may include or cover 16 index entries. In implementations, an index entry may have a size of 6 bytes, and may include a plurality of key fields, including, but are not limited to, a sector range (e.g., bits 0˜9, 10 bits in size), a logical size (e.g., bits 10˜22, 13 bits in size), and a relative start offset (e.g., bits 23˜47, 25 bits in size). In implementations, the relative start offset is relative to a base start offset of the index fragment. In implementations, the format_8 header may not have a different tombstone index entry format for a deleted record. In implementations, when a sector range of an index entry associated with a record has a designated value, such as 1023, this indicates that the record is deleted. Additionally, when a sector range of an index entry associated with a record has a certain value, such as 1022, this indicates that the record has become a tombstone. In implementations, a sector range may be calculated as relative sector ID×3+(sector count−1). Correspondingly, a relative sector ID may be derived or determined as (sector range/3), and a sector count may derived or determined as (sector range % 3+1).

### Format Conversion

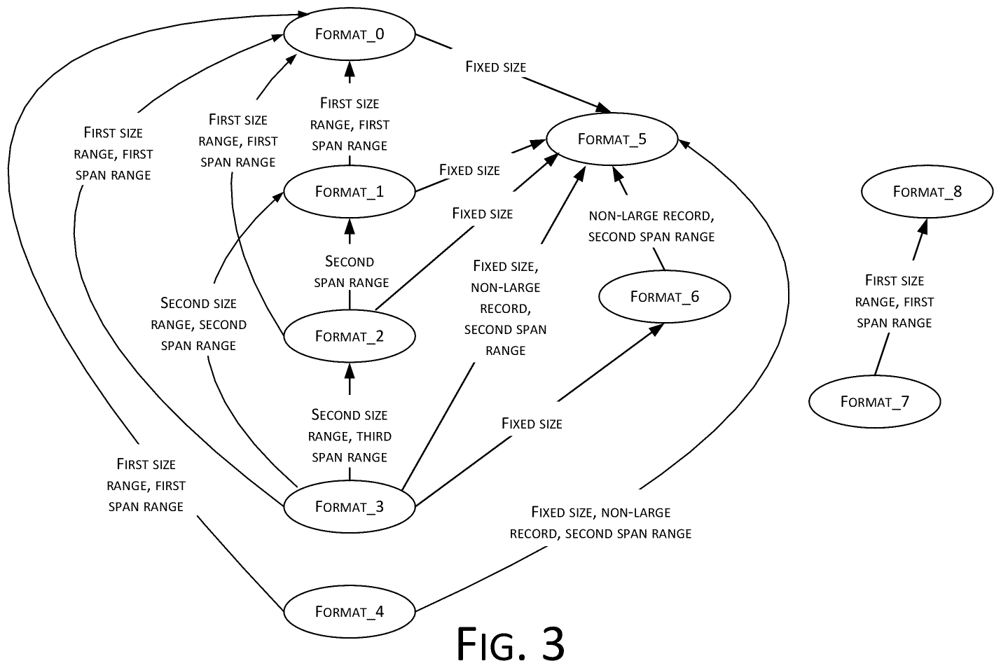

In implementations, when an index fragment is open to accumulate index entries for new records to be added or appended from users or garbage collection, a format with a relatively large amount of memory usage, which is capable of handling records with record properties having a variety of different ranges, may be used first. When more records that are added or appended are inspected, another format with a smaller amount of memory usage may be used or determined to index those records. In this case, the index fragment may be converted to the other format with the smaller amount of memory usage. By way of example and not limitation, using the above example of nine different formats, FIG. 3 shows a schematic diagram depicting an example decision graph 300 for performing example conversions or transformations among different formats. Under the same set of records with record properties having a variety of different ranges, format_3 may have the largest amount of memory consumption, and may be capable of handling these records, among formats with continuous keys. An directed line that starts from one format (such as a first format) and ends at another format (such as a second format) represents a potential or possible conversion from the first format to the second format, with the second format consuming a less amount of memory as compared to the first format after the conversion. One or more conditions that need to be fulfilled before the conversion can be performed are also shown along the directed line, for example.

### Example Method

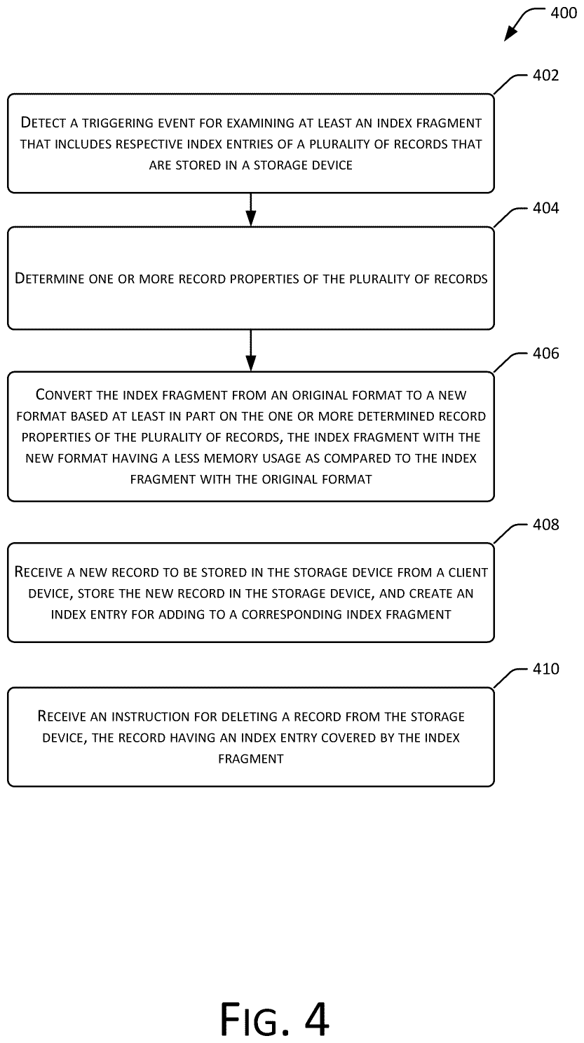

FIG. 4 shows a schematic diagram depicting an example method of generating or updating a record-level index. The method of FIG. 4 may, but need not, be implemented in the environment of FIG. 1, using the system of FIG. 2, and the graph of FIG. 3. For ease of explanation, method 400 is described with reference to FIGS. 1-3. However, the method 400 may alternatively be implemented in other environments and/or using other systems.

The method 400 is described in the general context of computer-executable instructions. Generally, computer-executable instructions can include routines, programs, objects, components, data structures, procedures, modules, functions, and the like that perform particular functions or implement particular abstract data types. Furthermore, each of the example methods are illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 4, at block 402, the storage engine 102 may detect a triggering event for examining at least one index fragment that includes respective index entries of a plurality of records that are stored in a storage device.

In implementations, the storage engine 102 may receive or detect a triggering event to cause the storage engine to examine at least an index fragment that includes respective index entries of a plurality of records that are stored in a storage device (such as the storage device 112) (or keys of the plurality of records fall within a sub-key range of the index fragment). In implementations, the triggering event may include, but is not limited to, an occurrence of an operation of garbage collection to be performed on the storage device 112, an occurrence of a regular maintenance operation for index fragments stored in a memory (such as the memory 204) of the storage engine 102, or a receipt of an instruction for examining the storage device or one or more index fragments (including the index fragment) stored and generated in the memory of the storage engine 102 from a user of the storage engine 102 or a client device (such as the client device 110). In implementations, if the at least one index fragment includes more than one index fragment, the storage engine 102 may perform the following operations or method blocks separately or independently for each index fragment.

At block 404, the storage engine 102 may determine one or more record properties of the plurality of records.

In implementations, the storage engine 102 may determine or examine record properties of the plurality of records whose index entries are included in the index fragment. As described in the foregoing description, the record properties of the plurality of records may include, but are not limited to, whether keys of the plurality of records are continuous or discrete, whether logical and/or physical sizes of the plurality of records are fixed or varied (and/or same or different), the number of sectors that are used to store or include the plurality of records in the storage device, whether the sectors that are used to store or include the plurality of records are adjacent to each other in the storage device, etc.

At block 406, the storage engine 102 may convert the index fragment from an original format to a new format based at least in part on the one or more determined record properties of the plurality of records, the index fragment with the new format having a less memory usage as compared to the index fragment with the original format.

In implementations, depending on a determination result of the record properties of the plurality of records and an original format of the index fragment, the storage engine 102 may perform a format conversion for the index fragment to convert or transform the index fragment from the original format to a new format which consumes a less amount of memory space (such as a memory space in the memory 204 associated with the storage engine 102) as compared to the original format, so that a less memory consumption or usage can be achieved to make room for accommodating more index entries of additional records, and to further enhance the search efficiency by reducing an amount of data to be searched.

In implementations, a plurality of formats for index fragments may be predefined by a user of the storage engine 102 for each storage device (such as each of the storage devices 112). In implementations, different types of storage devices may have same or different storage configurations, such as same or different defined sizes or size limits for a chunk (e.g., in units of megabytes, etc.), same or different defined sizes or size limits for a superblock (e.g., in units of physical consecutive sectors, for example), same or different sizes or size limits for a sector (e.g., in units of kilobytes, etc.), same or different defined sizes or size limits for a record (e.g., in units of megabytes, for example), etc. Accordingly, although a format (of the plurality of formats) may have the same types and the same number of fields used for different types of storage devices, the number of bits allocated for each field of the format may or may not be the same for different types of storage devices, which may depend on, for example, storage configurations defined for the respective storage devices. Additionally, criteria (such as corresponding values for logical or physical size ranges, corresponding values for sector span ranges, etc.) for selecting or generating a particular format from the plurality of formats may or may not be the same for different types of storage devices, which may depend on, for example, storage configurations defined for the respective storage devices.

By way of example and not limitation, the above example storage configuration of a storage device, the nine example index fragment formats, and the example decision graph of FIG. 4 are used herein for illustration. It should be noted that the shown or described format conversions or transformations are merely examples. Format conversions or transformations that are different from those shown in FIG. 4 and described herein are also possible, depending on what formats and how many formats are defined for index fragments for a corresponding storage device (or corresponding storage devices), and criteria that are used for selecting a particular format from the formats that are defined.

For example, as shown in FIG. 4, if the original format of the index fragment is format_3, the storage engine 102 may convert the original format (i.e., format_3 in this example) of the index fragment to a new format (such as format_6) if the plurality of records associated with this index fragment have the same or fixed logical size, for example. Alternatively, if the original format of the index fragment is format_3, the storage engine 102 may convert the original format (i.e., format_3 in this example) of the index fragment to a new format (such as format_1) if logical sizes of the plurality of records associated with the index fragment are within the second logical size range and a sector span of the plurality of records is within the second sector span range, for example. In other words, the storage engine 102 may generate or establish a decision graph (such as the decision graph 300 as shown in FIG. 3) based on a plurality of formats of index fragments defined for a storage device (such as the storage device 112) in advance. The storage engine 102 may then convert or transform an initial format of an index fragment that includes index entries of records stored in the storage device to another format based at least in part on one or more record properties of the records as described above.

At block 408, the storage engine 102 may receive a new record to be stored in the storage device from a client device, store the new record in the storage device, and create an index entry for adding to a corresponding index fragment.

In implementations, the storage engine 102 may receive a new record to be stored in the storage device from a client device. In response to receiving the new record to be stored, the storage engine 102 may store the new record into the storage device. The storage engine 102 may further create a new index entry for the new record, and add the new index entry to the index fragment with the original format or the new format, depending on when the new record is received by the storage engine 102. In implementations, a key associated with the new record is within a sub-key range of the index fragment with the original format or the new format. Alternatively, if the key associated with the new record is within a sub-key range of another index fragment, the storage engine 102 may further add the new index entry to the other index fragment whose sub-key range covers the key of the record.

At block 410, the storage engine 102 may receive an instruction for deleting a record from the storage device, the record having an index entry covered by the index fragment.

In implementations, the storage engine 102 may receive an instruction for deleting a record from the storage device 112. For example, the storage engine 102 may receive an instruction for deleting a record having an index entry covered by the index fragment. Depending on a current format (e.g., the original format or the new format) of the index fragment that is used at the time when the storage engine 102 receives the instruction, the storage engine 102 may either delete the index entry of the record from the index fragment, or set at least a special value in the index entry of the record in the index fragment to indicate that the record is deleted, before an operation of garbage collection is performed.

In implementations, some or all of the method blocks may be performed periodically or in response to an occurrence of a new event (e.g., a new triggering event, a receipt of a new record to be stored, etc.). Furthermore, although the above method blocks are described to be executed in a particular order, in some implementations, some or all of the method blocks can be executed in other orders, or in parallel.

### CONCLUSION

Although implementations have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, FPGAs, or other hardware.

The present disclosure can be further understood using the following clauses.

Clause 1: A method implemented by one or more processors of a storage engine, the method comprising: detecting a triggering event for examining at least an index fragment that includes respective index entries of a plurality of records that are stored in a storage device; determining one or more record properties of the plurality of records; and converting the index fragment from an original format to a new format based at least in part on the one or more determined record properties of the plurality of records, the index fragment with the new format having a less memory usage as compared to the index fragment with the original format.

Clause 2: The method of Clause 1, wherein the triggering event comprises an occurrence of an operation of garbage collection to be performed on the storage device, an occurrence of a regular maintenance operation for index fragments stored in a memory of the storage engine, or a receipt of an instruction from a user of the storage engine.

Clause 3: The method of Clause 1, wherein the one or more record properties of the plurality of records comprise at least one of: logical sizes of the plurality of records, whether logical sizes of the plurality of records are identical to each other, or a sector span of the plurality of records.

Clause 4: The method of Clause 1, wherein converting the index fragment from the original format to the new format is based further on whether keys of the plurality of records in the index fragment are continuous or discrete.

Clause 5: The method of Clause 1, further comprising selecting the new format from a plurality of predefined formats, each of the plurality of predefined formats having a different index fragment header format and/or a different index entry format.

Clause 6: The method of Clause 1, wherein a respective index entry of a record of the plurality of records comprises at least a part of information of mapping a key associated with the record to a physical location of the record in the storage device.

Clause 7: The method of Clause 1, further comprising: receiving a new record to be stored in the storage device from a client device; storing the new record into the storage device; and creating a new index entry for the new record, and adding the new index entry to the index fragment with the new format in response to a key associated with the new record is within a sub-key range of the index fragment with the new format.

Clause 8: The method of Clause 1, further comprising: receiving an instruction for deleting a record from the storage device, the record having an index entry covered by the index fragment with the new format; and based on the new format of the index fragment, deleting the index entry of the record from the index fragment or setting at least a special value in the index entry of the record in the index fragment to indicate that the record is deleted, before an operation of garbage collection is performed.

Clause 9: One or more processor readable media storing executable instructions that, when executed by one or more processors of a storage engine, cause the one or more processors to perform acts comprising: detecting a triggering event for examining at least an index fragment that includes respective index entries of a plurality of records that are stored in a storage device; determining one or more record properties of the plurality of records; and converting the index fragment from an original format to a new format based at least in part on the one or more determined record properties of the plurality of records, the index fragment with the new format having a less memory usage as compared to the index fragment with the original format.

Clause 10: The one or more processor readable media of Clause 9, wherein the triggering event comprises an occurrence of an operation of garbage collection to be performed on the storage device, an occurrence of a regular maintenance operation for index fragments stored in a memory of the storage engine, or a receipt of an instruction from a user of the storage engine.

Clause 11: The one or more processor readable media of Clause 9, wherein the one or more record properties of the plurality of records comprise at least one of: logical sizes of the plurality of records, whether logical sizes of the plurality of records are identical to each other, or a sector span of the plurality of records.

Clause 12: The one or more processor readable media of Clause 9, wherein converting the index fragment from the original format to the new format is based further on whether keys of the plurality of records in the index fragment are continuous or discrete.

Clause 13: The one or more processor readable media of Clause 9, the acts further comprising selecting the new format from a plurality of predefined formats, each of the plurality of predefined formats having a different index fragment header format and/or a different index entry format.

Clause 14: The one or more processor readable media of Clause 9, wherein a respective index entry of a record of the plurality of records comprises at least a part of information of mapping a key associated with the record to a physical location of the record in the storage device.

Clause 15: The one or more processor readable media of Clause 9, the acts further comprising: receiving a new record to be stored in the storage device from a client device; storing the new record into the storage device; and creating a new index entry for the new record, and adding the new index entry to the index fragment with the new format in response to a key associated with the new record is within a sub-key range of the index fragment with the new format.

Clause 16: The one or more processor readable media of Clause 9, the acts further comprising: receiving an instruction for deleting a record from the storage device, the record having an index entry covered by the index fragment with the new format; and based on the new format of the index fragment, deleting the index entry of the record from the index fragment or setting at least a special value in the index entry of the record in the index fragment to indicate that the record is deleted, before an operation of garbage collection is performed.

Clause 17: A storage engine comprising: one or more processors; and memory storing executable instructions that, when executed by the one or more processors, cause the one or more processors to perform acts comprising: detecting a triggering event for examining at least an index fragment that includes respective index entries of a plurality of records that are stored in a storage device; determining one or more record properties of the plurality of records; and converting the index fragment from an original format to a new format based at least in part on the one or more determined record properties of the plurality of records, the index fragment with the new format having a less memory usage as compared to the index fragment with the original format.

Clause 18: The storage engine of Clause 17, wherein the one or more record properties of the plurality of records comprise at least one of: logical sizes of the plurality of records, whether logical sizes of the plurality of records are identical to each other, or a sector span of the plurality of records.

Clause 19: The storage engine of Clause 17, the acts further comprising: receiving a new record to be stored in the storage device from a client device; storing the new record into the storage device; and creating a new index entry for the new record, and adding the new index entry to the index fragment with the new format in response to a key associated with the new record is within a sub-key range of the index fragment with the new format.

Clause 20: The storage engine of Clause 17, the acts further comprising: receiving an instruction for deleting a record from the storage device, the record having an index entry covered by the index fragment with the new format; and based on the new format of the index fragment, deleting the index entry of the record from the index fragment or setting at least a special value in the index entry of the record in the index fragment to indicate that the record is deleted, before an operation of garbage collection is performed.

What is claimed is:

1. A method implemented by one or more processors of a storage engine, the method comprising:
detecting a triggering event for examining at least an index fragment that includes respective index entries of a plurality of records that are stored in a storage device;
determining one or more record properties of the plurality of records; and
converting the index fragment from an original format to a new format based at least in part on the one or more determined record properties of the plurality of records, the index fragment with the new format having a less memory usage as compared to the index fragment with the original format.

2. The method of claim 1, wherein the triggering event comprises an occurrence of an operation of garbage collection to be performed on the storage device, an occurrence of a regular maintenance operation for index fragments stored in a memory of the storage engine, or a receipt of an instruction from a user of the storage engine.

3. The method of claim 1, wherein the one or more record properties of the plurality of records comprise at least one of: logical sizes of the plurality of records, whether logical sizes of the plurality of records are identical to each other, or a sector span of the plurality of records.

4. The method of claim 1, wherein converting the index fragment from the original format to the new format is based further on whether keys of the plurality of records in the index fragment are continuous or discrete.

5. The method of claim 1, further comprising selecting the new format from a plurality of predefined formats, each of the plurality of predefined formats having a different index fragment header format and/or a different index entry format.

6. The method of claim 1, wherein a respective index entry of a record of the plurality of records comprises at least a part of information of mapping a key associated with the record to a physical location of the record in the storage device.

7. The method of claim 1, further comprising:
receiving a new record to be stored in the storage device from a client device;
storing the new record into the storage device; and
creating a new index entry for the new record, and adding the new index entry to the index fragment with the new format in response to a key associated with the new record is within a sub-key range of the index fragment with the new format.

8. The method of claim 1, further comprising:
receiving an instruction for deleting a record from the storage device, the record having an index entry covered by the index fragment with the new format; and
based on the new format of the index fragment, deleting the index entry of the record from the index fragment or setting at least a special value in the index entry of the record in the index fragment to indicate that the record is deleted, before an operation of garbage collection is performed.

9. One or more processor readable media storing executable instructions that, when executed by one or more processors of a storage engine, cause the one or more processors to perform acts comprising:
detecting a triggering event for examining at least an index fragment that includes respective index entries of a plurality of records that are stored in a storage device;
determining one or more record properties of the plurality of records; and
converting the index fragment from an original format to a new format based at least in part on the one or more determined record properties of the plurality of records, the index fragment with the new format having a less memory usage as compared to the index fragment with the original format.

10. The one or more processor readable media of claim 9, wherein the triggering event comprises an occurrence of an operation of garbage collection to be performed on the storage device, an occurrence of a regular maintenance operation for index fragments stored in a memory of the storage engine, or a receipt of an instruction from a user of the storage engine.

11. The one or more processor readable media of claim 9, wherein the one or more record properties of the plurality of records comprise at least one of: logical sizes of the plurality of records, whether logical sizes of the plurality of records are identical to each other, or a sector span of the plurality of records.

12. The one or more processor readable media of claim 9, wherein converting the index fragment from the original format to the new format is based further on whether keys of the plurality of records in the index fragment are continuous or discrete.

13. The one or more processor readable media of claim 9, the acts further comprising selecting the new format from a plurality of predefined formats, each of the plurality of predefined formats having a different index fragment header format and/or a different index entry format.

14. The one or more processor readable media of claim 9, wherein a respective index entry of a record of the plurality of records comprises at least a part of information of mapping a key associated with the record to a physical location of the record in the storage device.

15. The one or more processor readable media of claim 9, the acts further comprising:
receiving a new record to be stored in the storage device from a client device;
storing the new record into the storage device; and
creating a new index entry for the new record, and adding the new index entry to the index fragment with the new format in response to a key associated with the new record is within a sub-key range of the index fragment with the new format.

16. The one or more processor readable media of claim 9, the acts further comprising:
receiving an instruction for deleting a record from the storage device, the record having an index entry covered by the index fragment with the new format; and
based on the new format of the index fragment, deleting the index entry of the record from the index fragment or setting at least a special value in the index entry of the record in the index fragment to indicate that the record is deleted, before an operation of garbage collection is performed.

17. A storage engine comprising:
one or more processors; and
memory storing executable instructions that, when executed by the one or more processors, cause the one or more processors to perform acts comprising:
detecting a triggering event for examining at least an index fragment that includes respective index entries of a plurality of records that are stored in a storage device;
determining one or more record properties of the plurality of records; and
converting the index fragment from an original format to a new format based at least in part on the one or more determined record properties of the plurality of records, the index fragment with the new format having a less memory usage as compared to the index fragment with the original format.

18. The storage engine of claim 17, wherein the one or more record properties of the plurality of records comprise at least one of: logical sizes of the plurality of records, whether logical sizes of the plurality of records are identical to each other, or a sector span of the plurality of records.

19. The storage engine of claim 17, the acts further comprising:
receiving a new record to be stored in the storage device from a client device;
storing the new record into the storage device; and
creating a new index entry for the new record, and adding the new index entry to the index fragment with the new format in response to a key associated with the new record is within a sub-key range of the index fragment with the new format.

20. The storage engine of claim 17, the acts further comprising:
receiving an instruction for deleting a record from the storage device, the record having an index entry covered by the index fragment with the new format; and
based on the new format of the index fragment, deleting the index entry of the record from the index fragment or setting at least a special value in the index entry of the record in the index fragment to indicate that the record is deleted, before an operation of garbage collection is performed.
